(19) United States
(12) Patent Application Publication
(10) Pub. No.: US 2009/0032611 A1
(43) Pub. Date: Feb. 5, 2009

(54) PUMPING MECHANISM FOR FOUNTAIN

(75) Inventors: Nathaniel Fulton, Marietta, OH (US); Kevin McGuire, Sunbury, OH (US)

Correspondence Address: HAHN LOESER & PARKS, LLP, One GOJO Plaza, Suite 300, AKRON, OH, 44311-1076, US

(73) Assignee: RAMPP COMPANY, Marietta, OH (US)

(21) Appl. No.: 11/833,725

(22) Filed: Aug. 3, 2007

(51) Int. Cl. B05B 17/08; B05B 1/36; B05B 17/00

(52) U.S. Cl. 239/23; 239/17; 239/211

(57) ABSTRACT

A floating fountain includes multiple pumps that combine respective outputs into a mixing chamber that is configured to disperse fluid and more specifically water through an outlet port. The pumps may be similar in power rating and configuration and may be connected to the mixing chamber via one or more conduits. Fluid is forced under pressure through the outlet and past a diverter for dispersing the fluid in an ornate manner.

### TECHNICAL FIELD

The present invention relates to fountains and more particularly to a floating fountain utilizing a plurality of pumps connected to a mixing chamber. The mixing chamber allows a higher flow rate to be supplied to the fountain by the pumps at a lower cost and weight than a single pump.

### BACKGROUND OF THE INVENTION

Fountains are known for providing aeration and aesthetics to small bodies of water. The devices may include stationary or floating fountains. In such devices, a pump draws in water through an intake and disperses the water under pressure through an outlet into any of a variety of ornate representations. To achieve the desired affect, the water is forced through nozzles. Accordingly, the water may be dispersed in a vertical and/or annular manner or any other pattern as directed by the nozzles. For greater height and breadth, typically, a larger output capacity pump is needed.

To obtain a particular dispersal pattern, which may pertain to a specific height or number of cascading streams, some fountain pumps may be quite large extending up to, and in some cases larger than, 3 HP. However, large pumps are inherently heavy, draw more electrical power than smaller units and have lower efficiencies than smaller pumps. Additionally, the configuration of assembling a large pump to the fountain producing device results in a dimensionally tall system that may not be suitable for shallower bodies of water. Larger current draws also require increased wire diameter and possess greater potential for shock hazard.

What is needed is a fountain device that utilizes a more compact pumping system that still possesses the requisite output to achieve the desired water fountain patterns. The embodiments of the present invention obviate the aforementioned problems.

### BRIEF SUMMARY

In one embodiment of the present invention a device for producing a fountain may include a chamber having at least a first inlet for receiving pressurized fluid and one or more outlets configured to disperse the pressurized fluid in an ornate manner and multiple pumps each having a pressurized fluid output, wherein the output from each of the multiple pumps are fluidly connected in tandem to the chamber.

In one aspect of the embodiments of the present invention the at least a first inlet comprises a plurality of inlets operatively connected to a first end of the chamber, and wherein the plurality of inlets are fluidly communicated to multiple pumps respectively.

In another aspect of the embodiments of the present invention the device includes a diverter extending from a second open end of the chamber for dispersing the fluid in an ornate manner.

In yet another aspect of the embodiments of the present invention each of the multiple pumps has a substantially similar pumping output capacity, where the power rating of each of the multiple pumps may be in the range between ¼ HP and ¾ HP and more specifically ½ HP.

In even another aspect of the embodiments of the present invention the device may include a buoyant member operatively connected with respect to the pumps for increasing the buoyancy of the device. The buoyant member may be comprised of individual buoyant cells.

In another embodiment of the present invention a device for producing a fountain may include a mixing chamber having a first and at least a second mixing chamber sections isolated from each other to prevent pressurized fluid from intermixing, a first plurality of pumps fluidly connected to the first mixing chamber section, which may be two or more pumps, and at least a third pump fluidly connected to the at least a second mixing chamber.

In one aspect of the embodiments of the present invention the first and at least a second mixing chamber sections are fluidly communicated to different outlets, where the first mixing chamber section defines a substantially larger volume than the at least a second mixing chamber section.

In another aspect of the embodiments of the present invention the output capacity of each of the first plurality of pumps is substantially similar.

In yet another aspect of the embodiments of the present invention the at least a second mixing chamber section is received at least partially within the first mixing chamber section.

In another embodiment of the present invention, a method of producing a water fountain includes the steps of providing a mixing chamber having first and second ends and one or more inlets operatively connected to the first end, wherein the mixing chamber is operable to disperse an associated fluid from the second end, and communicating the output of the plurality of pumps to the mixing chamber via the one or more inlets.

### BRIEF DESCRIPTION OF THE DRAWINGS

FIG. 1 is a perspective view of a small body of water in which the fountain device may reside for producing a water fountain according to the embodiments of the invention.

FIG. 2 is a perspective view of a device for producing a fountain showing multiple pumps having respective outputs connected to a mixing chamber according to the embodiments of the invention.

FIG. 3 is a partial cutaway side view of a device for producing a fountain showing multiple pumps according to the embodiments of the invention.

FIG. 4 is a perspective view of a mixing chamber having multiple mixing chamber sections according to the embodiments of the invention.

FIG. 5 is a schematic representation of a bottom view of a device for producing a fountain showing multiple pumps according to the embodiments of the invention.

### DETAILED DESCRIPTION OF THE INVENTION

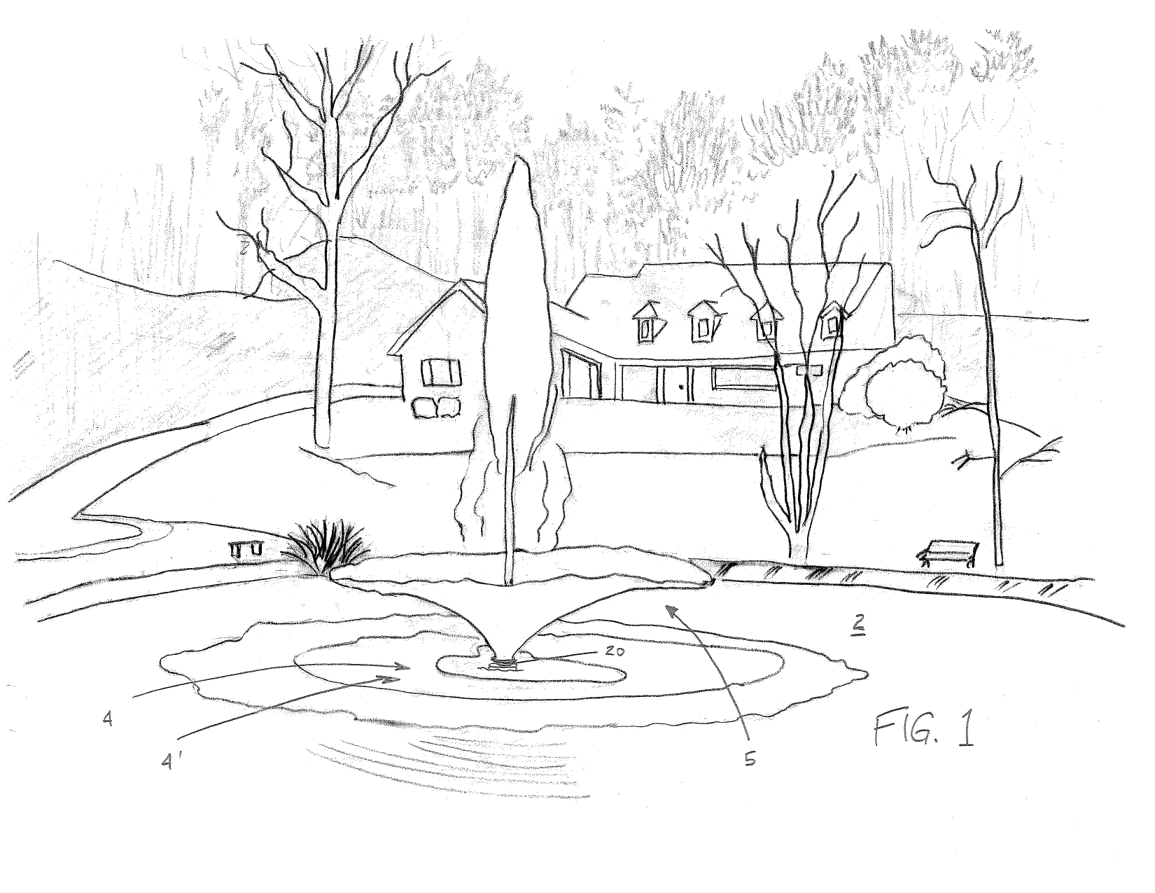

Referring now to the drawings wherein the showings are for purposes of illustrating embodiments of the invention only and not for purposes of limiting the same, FIG. 1 shows a body of water 2 in which a fountain device 4 may be placed for producing a fountain depicted generally at 5. The fountain device 4 may produce a stream or streams of fluid, which may be water, in an ornate fashion. To disperse the water, the fountain device 4 may include a mechanism 7, which draws water in through an inlet and pressurizes the water for delivery through an outlet port. A pump 8 is one type of mechanism 7 for producing pressurized fluid output. The pump 8 may be a roto-dynamic pump, a positive displacement pump or any type of pump having output power sufficient to force water through the outlets. Accordingly, the pump 8 may include an impeller, not shown, for generating flow from within the body of the pump 8. Alternatively, the pump 8 may include vanes or pistons. Although any type of pump 8 or pumping mechanism 7′ may be utilized as chosen with sound engineering judgment. The fountain device 4 may include multiple pumps 8 as will be discussed below in detail. Output from the pumping mechanism 7′ may direct water into a chamber 11 where it is subsequently channeled outward through outlet 20. The chamber 11 may comprise a hollow body 12 having first and second ends 14, 15. Inlets 18 may be fashioned in the first end 14 for receiving water into the chamber 11 from the pumping mechanism 7′. A diverter 25, or separator, may be affixed to the second end 15 of the chamber body 12 for use in directing water outward in an ornate fashion. In one embodiment, the fountain device 4 may be a floating fountain device 4′. As such, the fountain device 4 may include one or more buoyant members 28 used to keep the fountain device 4 afloat. It is contemplated in an alternative embodiment that the fountain device 4 may not be a floating fountain device 4, but rather may be fixedly connected to a grounded structure in any manner chosen with sound judgment. It is noted that the fountain device 4 is illustrated as being used in a pond 2 or small lake 2. However, persons of ordinary skill in the art will realize its application to any size body of water. Additionally, it is to be construed that the embodiments of the present invention may be utilized in any body of water including but not limited to indoor bodies of water, and man-made or naturally occurring bodies of water.

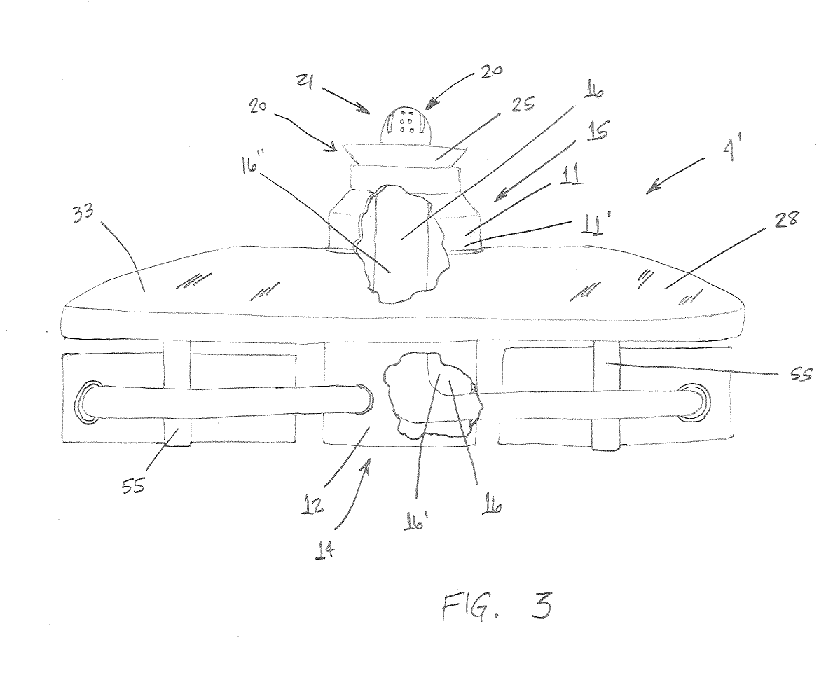

With reference to FIGS. 1 through 3, as mentioned above the fountain device 4 may include a buoyant member 28 for increasing the buoyancy of the fountain device 4. The buoyant member 28 may serve as platform or base 33 onto which one or more of the components of the fountain device 4 may be mounted. Accordingly, the base 33 may be substantially rigid. However, semi-rigid or pliable buoyant members may also be utilized without limiting the scope of coverage of the embodiments of the present invention. The buoyant member 28 may also have an open space or aperture formed therein from which the second end 15 of the chamber 11 may extend for dispersing the water in an ornate fashion. The assembly of the buoyant member 28 in relation to the second end 15 of the chamber 11 may be such that the outlet 20 extends above the surface level of the water by a distance D, which may be in the range between substantially 0, i.e. at water level, and 5 inches. The buoyant member 28 may be submersed at least partially beneath the surface of the water. In particular, the buoyant member 28 may be constructed so that the upper surface of the buoyant member 28 extends above the surface level of the water by any amount chosen with sound engineering judgment. The configuration of the base 33 may be generally disk shaped and constructed from a light weight material such as polypropylene. Other types of material may also be used as is appropriate for maintaining the buoyancy of the fountain device 4. The buoyant member 28 may be hollow and sealed to prevent water from leaking in which may decrease its buoyancy and its ability to keep the fountain device 4 afloat. In one embodiment, the buoyant member 28 may have a cellular makeup. That is to say that the buoyant member 28 may be constructed from individual cells or buoyant segments connected together to comprise the buoyant member 28. Accordingly, the buoyant member 28 may include a rigid frame or any structure suitable onto which the buoyant segments may be mounted. However, it is to be construed that any configuration of buoyant member 28 may be utilized without departing from the scope of coverage of the embodiments of the present invention.

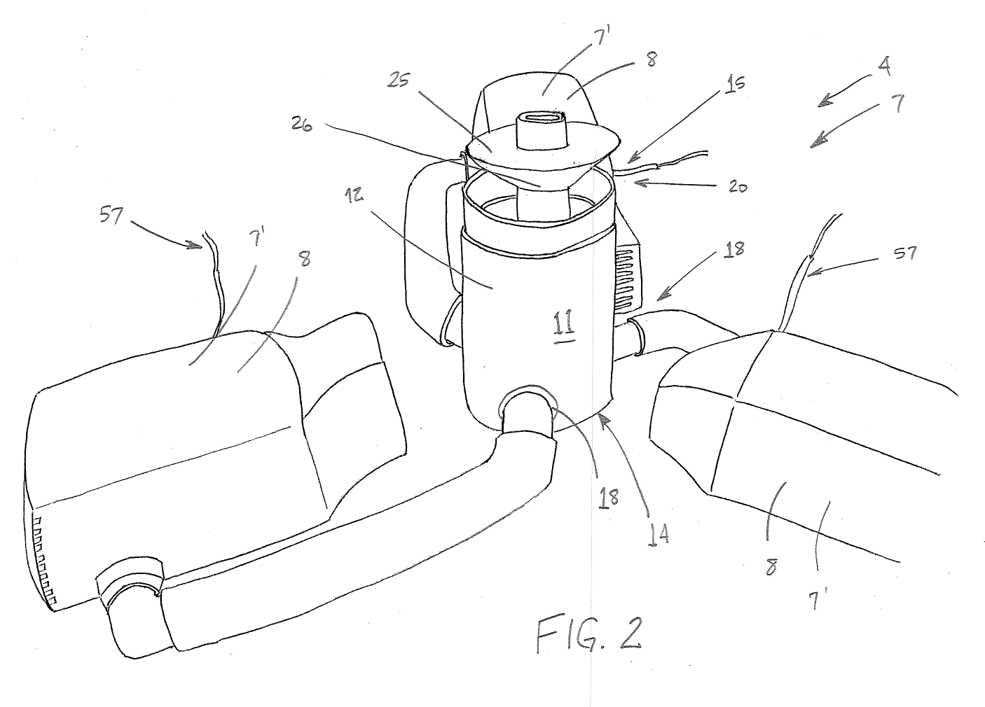

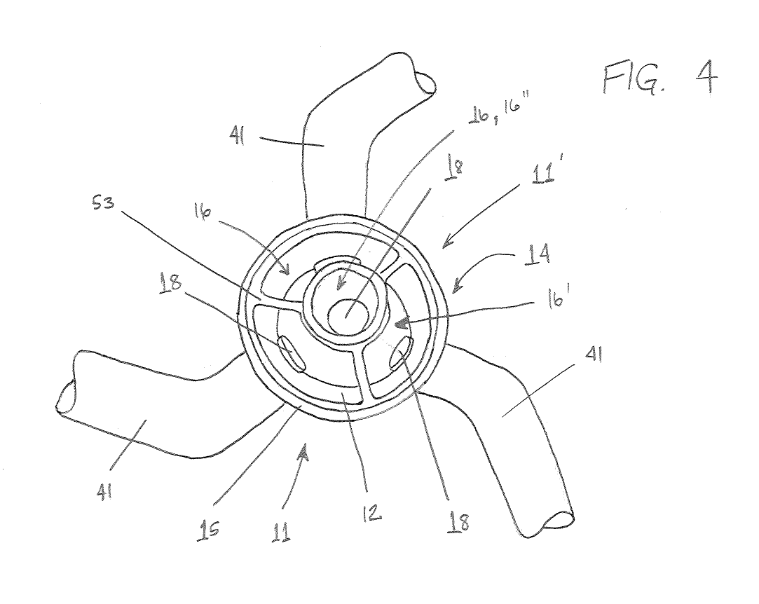

With reference to FIGS. 2 and 4, the body 12 of the chamber 11 may be comprised of a generally tubular structure. The tubular chamber 11 may have a circular cross section. Although other cross sectional configurations may be chosen without departing from the intended scope of coverage. The first end 14 of the chamber 11 may be closed or capped. One or more inlets 18 may be fashioned in the first end 14 for receiving pressurized water from the pumping mechanism 7′. The inlets 18 may be positioned proximal to the first end 14 and spaced radially about the perimeter of the chamber body 12. It is contemplated in an alternative embodiment that one or all of the inlets 18 may be spaced axially apart from the first end 14 and closer to the midsection of the chamber body 12. However, any spacing configuration or manner of connecting the inlets 18 to the chamber 11 may be chosen as is appropriate for use with the embodiments of the present invention. The second end 15 of the chamber body 12 may include an outlet 20 for allowing the pressurized water from the pumping mechanism 7′ to disperse outward past the diverter 25. The diverter 25 may have a cone or frustoconical shape and may be oriented such that the tip 26, or narrow end, of the diverter 25 may be pointing toward the interior of the chamber body 12. In this manner, water flowing through the chamber body 12 may be channeled outward around the periphery of the diverter 25. Any angle of the cone sides, with respect to the centerline axis of the cone, may be chosen as is appropriate for use with the embodiments of the present invention. The diverter 25 described herein is exemplary in nature. Persons of ordinary skill in the art will readily understand the application of any type or configuration of diverter member or outlet. In this manner, the opening between the chamber body walls and the diverter 25 may comprise the outlet 20 or outlet ports of the chamber 11 through which the water is dispersed.

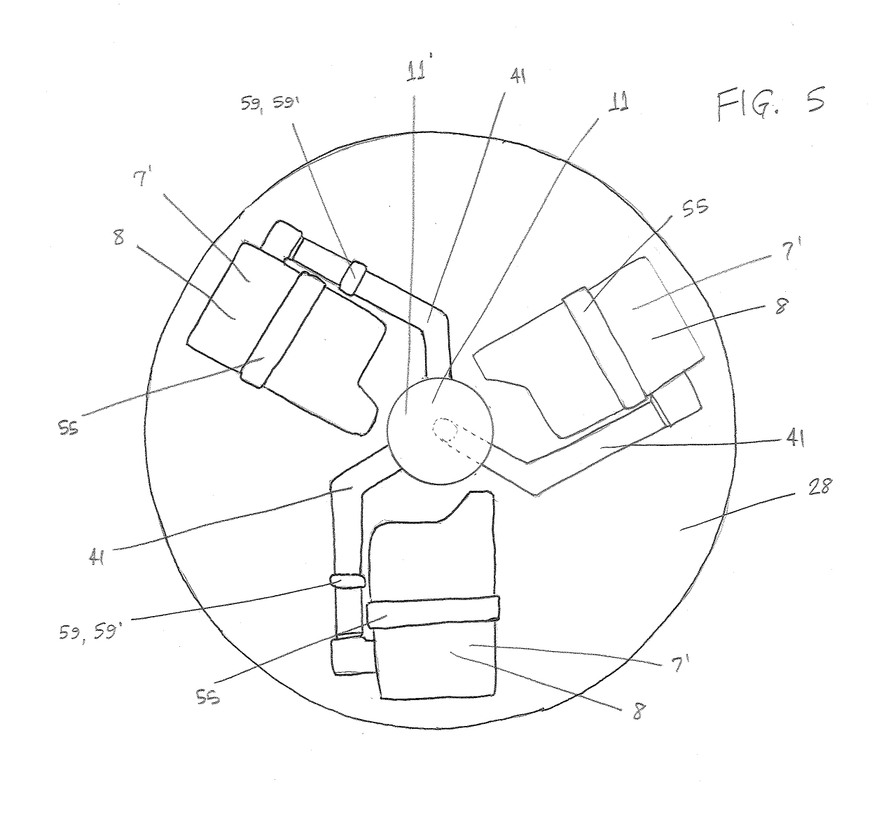

With reference now to FIGS. 2 through 5, the pumping mechanism 7′ may include multiple pumps 8. Each of the plurality of pumps 8 may be the same or substantially similar. For example, each of the plurality of pumps 8 may have the same power rating. More specifically, each pump 8 may be an Ecosub 420 manufactured by Leader Pumps Inc. rated at ½ HP and may be a submergible pump 8. However, it is to be construed that any type and make of pump 8 may be chosen as is appropriate for use with the embodiments of present invention. The pumps 8 may include an outlet port delivering pressurized fluid. The outlet ports of each of the pumps 8 may be communicated to the inlets 18 of the chamber 11 in a manner consistent with the embodiments described above. As such, the plurality of pumps 8 feed a common chamber 11, which may also be called a mixing chamber 11′. In one embodiment, the fountain device 4 may include three (3) pumps spaced radially about the mixing chamber 11′. Conduits 41 may be connected between the pump outlets and the inlets 18 respectively to direct pressurized fluid flow into the chamber 11. The conduits 41 may be made of lightweight material, for example a moldable polymer, which may be extruded into tubes and sized or cut to any length appropriate for use with the embodiments of the present invention. However, any type of conduit or manner of constructing the conduit may be chosen with sound judgment. In this manner, the fluid outputs from the plurality of pumps 8 respectively combine in the mixing chamber 11′ to increase fluid flow with respect to a single pump.

With reference now to FIGS. 1 through 5, in another embodiment of the present invention, the mixing chamber 11′ may be divided into multiple separate mixing chamber sections 16. Each mixing chamber section 16 may be isolated from the other mixing chamber sections 16. That is to say that the fluid from one mixing chamber section 16 may not mix with the fluid from the other mixing chamber sections 16. For example, the mixing chamber 11′ may be divided into two (2) mixing chamber sections 16. However, it is to be construed that any number of mixing chamber sections 16 may be incorporated into the embodiments of the present invention. Each mixing chamber section 16 may include its own outlet 20 for dispersing fluid therethrough in a manner consistent with the embodiments described above. Similarly, each mixing chamber section 16 may include one or more inlets 18. With reference to the example above including three (3) pumps, one mixing chamber section 16′ may include two inlets 18 fluidly connected to two of the pumps 8 respectively and the other mixing chamber 16″ may be connected to the remaining pump 8. It follows that, the outputs, from each of the two pumps 8, combine in the first mixing chamber section 16′ to increase fluid flow through the diverter 25 whereas the second mixing chamber section 16″ is only supplied by a single pump. It is to be understood that any combination or ratio of pumps to mixing chamber sections may be selected as chosen with sound judgment.

The second mixing chamber section 16″ may have a different configuration than the first mixing chamber section 16′. More specifically, the second mixing chamber section 16″ may have a different volume than that of the first mixing chamber section 16′. Although other embodiments are contemplated where the mixing chamber 16 may be divided into substantially equal and/or symmetrical sections. In the current example, the volume of the second mixing chamber section 16″ may be smaller than the first mixing chamber section 16′. The outlet 20, of the second mixing chamber section 16″, may also be different. The outlet of the second mixing chamber 16″ may include an enclosed cap having one or more openings 21 fashioned in the cap. For example, the cap may include an aperture, or a plurality of apertures for dispersing fluid therethrough. The apertures may be fashioned in the form slots and/or holes, or any combination thereof. Some apertures may also be larger than others. Additionally, it is contemplated that the outlet of the second mixing chamber section 16″ may include a diverter 25 similar to that of the first mixing chamber section 16′. Still any manner of constructing the first or second mixing chamber sections, the outlets and inlets may be chosen as is appropriate for use with the embodiments of the present invention.

The mixing chamber sections 16 may be constructed by inserting or fashioning walls in the mixing chamber 11′ that subdivide it accordingly. In the current example, the walls may be comprised of a separate inner tube extending at least partially into the interior of the mixing chamber 11′. Accordingly, the walls of the inner tube divide the mixing chamber 11′ into two isolated mixing chamber sections. The interior of the inner tube may comprise one mixing chamber section 16″. Similarly, the region between the exterior of the inner tube and the interior of the chamber body 12 may comprise the first mixing chamber section. As such, the inner tube may fluidly communicate to one of the pumps at the first end 14 thereof. The second end of the inner tube may be generally closed having apertures fashioned therein as described above. The inner tube may be stabilized from movement within the mixing chamber 11′ by one or more support members 53. The support member 53 may provide stability but may also allow water to flow through the first mixing chamber section 16′ relatively uninhibited. Still, any manner of constructing the second or a subsequent mixing chamber section 16″ and/or any manner of securing the walls separating the mixing chamber sections 16′, 16″ may be chosen as is appropriate for use with the embodiments of the present invention. In this way, the walls of the inner tube divide the mixing chamber 11′ into isolated mixing chamber sections. It is noted that the present example is not to be construed as limiting in any way. Any manner of subdividing the chamber body 12 to construct multiple mixing chamber sections may be chosen with sound engineering judgment.

It may be necessary to limit the flow of fluid within the conduits 41. To ensure the flow of fluid in only direction, a one way fluid flow limiter 59 may be connected between the output of a pump 8 and the mixing chamber 11′. One example of a device that limits the flow of a fluid in this manner is a check valve 59′. The check valve 59′ may be a ball check valve having a spring and associated spring force that must be overcome for flow to begin. It is to be construed that any device that prevents fluid from flowing from the mixing chamber 11′ to the output of the pump 8 may be utilized without limiting the scope of coverage of the embodiments of the present invention. In this manner, fluid may flows from the output of one pump 8 into the mixing chamber 11′ and does not flow back through a conduit 41 into another pump 8. In one embodiment, flow limiters 59 may be installed in each fluid circuit extending from the output of a pump 8 where multiple pumps 8 feed a common chamber 11. Persons of ordinary skill in the art will readily understand that mixing chamber sections 16 having only one associated pump mechanism 7′ may not require a flow limiter 59. It is noted here that other types of flow limiters may be utilized with the embodiments of the present invention including but not limited to pressure relief valves, flow diverting valves and the like.

With reference to all of Figures, assembly of the fountain device 4 will now be discussed. The mixing chamber 11′ may be constructed with one or more mixing chamber sections 16 as discussed above. The pumps 8 may then be fluidly connected to the one or more mixing chamber sections 16 via conduits 41. The conduits 41 may include fasteners or clamps that hold the conduits 41 in place with respect to the output of the pumps 8. The fasteners may also function to seal the flow of fluid from the pumps 8 to the inlets 18. Persons of ordinary skill in the art would recognize that reduced flow efficiency from the pumps 8 to the mixing chamber 11′ will result in the case of leakage from the fountain device 4. The outlet of one pump 8 may be connected to one corresponding inlet 18. However, other embodiments are contemplated where one pump 8 may be connected to two different inlets 18. The pumps 8, the mixing chamber 11′ and the conduits 41 may be then secured to the buoyant member 28 by fasteners, clamps 55 or any other means suitable for holding the components of the fountain device 4 together. The longitudinal axis of the pumps 8 may be orthogonally oriented to a centerline axis of the buoyant member 28 to minimize the height of the fountain device 4 for use in shallow water. Alternatively, the pumps 8 may be angled or positioned in any orientation appropriate for use with the embodiments of the present invention. Once assembled, conductors 57 associated with the pumps may be electrically connected to an electrical supply of power, which may be connected via a pump controller, not shown. Switches may be provided that allow the operator to turn the fountain device 4 on and off as desired.

The invention has been described herein with reference to the preferred embodiment. Obviously, modifications and alterations will occur to others upon a reading and understanding of this specification. It is intended to include all such modifications and alternations in so far as they come within the scope of the appended claims or the equivalence thereof.

I/We claim:

1. A device for producing a fountain, comprising:
a chamber having at least a first inlet for receiving pressurized fluid and one or more outlets configured to disperse the pressurized fluid in an ornate manner; and,
multiple pumps each having a pressurized fluid output, wherein the output from each of the multiple pumps are fluidly connected in tandem to the chamber.

2. The device as defined in claim 1, wherein the at least a first inlet comprises a plurality of inlets operatively connected to a first end of the chamber, and wherein the plurality of inlets are fluidly communicated to the multiple pumps respectively.

3. The device as defined in claim 2, further comprising:
a diverter extending from a second open end of the chamber for dispersing the fluid in an ornate manner.

4. The device as defined in claim 1, wherein each of the multiple pumps has a substantially similar pumping output capacity.

5. The device as defined in claim 4, wherein the power rating of each of the multiple pumps is in the range between ¼ HP and ¾ HP.

6. The device as defined in claim 1, further comprising a buoyant member operatively connected with respect to the pumps for increasing the buoyancy of the device.

7. The device as defined in claim 6, wherein when the device is floating in an associated body of water, the buoyant member and the multiple pumps are submerged beneath the surface of the associated body of water.

8. The device as defined in claim 1, further comprising:
a fluid flow limiter operatively connected between the output of at least one of the multiple pumps and the chamber.

9. A device for producing a fountain, comprising:
a mixing chamber having a first and at least a second mixing chamber sections isolated from each other to prevent pressurized fluid from intermixing;
a first plurality of pumps fluidly connected to the first mixing chamber section; and,
at least a third pump fluidly connected to the at least a second mixing chamber.

10. The device as defined in claim 9, wherein the first and at least a second mixing chamber sections are fluidly communicated to different outlets.

11. The device as defined in claim 9, wherein the first mixing chamber section defines a substantially larger volume than the at least a second mixing chamber section.

12. The device as defined in claim 9, wherein the output capacity of each of the first plurality of pumps is substantially similar.

13. The device as defined in claim 9, wherein the output capacity of each of the first plurality of pumps and the at least a third pump are substantially similar.

14. The device as defined in claim 13, wherein the output capacity of each of the first plurality of pumps and the at least a third pump are substantially ½ HP.

15. The device as defined in claim 9, wherein the first mixing chamber section has a generally closed first end and an open distal end, and further comprising:
a diverter having an angled deflecting portion extending circumferentially about the open distal end.

16. The device as defined in claim 15, wherein the at least a second mixing chamber section is received at least partially within the first mixing chamber section.

17. The device as defined in claim 15, further comprising:
at least a first buoyant member operatively attached to increase the buoyancy of the device, wherein the at least a first buoyant member includes an open center portion for receiving the mixing chamber.

18. A method of producing a water fountain, comprising the steps of:
providing a mixing chamber having first and second ends and one or more inlets operatively connected to the first end, wherein the mixing chamber is operable to disperse an associated fluid from the second end;
communicating the output of a plurality of pumps to the mixing chamber via the one or more inlets.

19. The method as defined in claim 18, further comprising the steps of:
providing a mixing chamber divided into two or more mixing chamber sections;
communicating the respective outputs of a first portion of the plurality of pumps to the first mixing chamber section; and,
communicating the respective outputs of the remaining portion of the plurality of pumps to the second mixing chamber section.

20. The method as defined in claim 18, further comprising the step of:
providing a plurality of pumps having substantially the same output pumping capacity.
